(19) United States
(12) Patent Application Publication
(10) Pub. No.: US 2023/0337629 A1
(43) Pub. Date: Oct. 26, 2023

(54) Treat Dispensing System

(71) Applicants: Davante Amir Rowe, Charlotte, NC (US); Robert Post, Ider, AL (US)

(72) Inventors: Davante Amir Rowe, Charlotte, NC (US); Robert Post, Ider, AL (US)

(73) Assignee: Davante Amir Rowe, Charlotte, NC (US)

(21) Appl. No.: 17/726,029

(22) Filed: Apr. 21, 2022

(51) Int. Cl. A01K 5/01; A01K 15/02

(52) U.S. Cl. CPC A01K 5/0114; A01K 15/02

(57) ABSTRACT

A dog treat dispensing system includes a glove having electrical contacts mounted on the glove for being selectively placeable in contact with one another, and a treat dispenser mounted on the glove and having a treat storage compartment for storing first treats to be dispensed, a computer controller in electronic communication with the electrical contacts and selectively controllable to control operation of a treat conveyor operable to convey the treats from the treat storage compartment toward a dispensing outlet. When the user places the electrical contacts on the glove in contact with one another the computer controller operates the treat conveyor to dispense one of the treats from the dispensing outlet.

### FIELD

This disclosure relates to the field of pet treat dispensing systems. More particularly, the disclosure relates to a treat dispensing system that is convenient to use and enables improved training of a dog.

### BACKGROUND

Improvement is desired in the dispensing of food treats to dogs, and particularly in the setting of dispensing of treats by dog handlers in the training and showing of dogs.

In the training of a dog a treat is typically dispensed to the dog upon completion of an act in response to a command. For example, if the handler gives a command such as “sit” and the dog responds by sitting, the handler will provide a treat to the dog as positive reinforcement. It is desirable to provide the treat to the dog quickly to the dog.

Typically, the dog is on a short leash proximate the handler. Conventionally, the treats are held in a pouch on the waist of the handler or the like and the handler has the reach into the pouch and grasp a treat to dispense. This is inconvenient and the time lag between the act of the dog and the rewarding of the treat can be detrimental to effective training.

The present disclosure fills this need in the art by providing a treat dispensing system that enables a handler to more conveniently and quickly dispense a treat as compared to reaching into a pouch or the like.

The treat dispensing system is also advantageously configured to enable a treat to be dispensed even if the dog is remote from the handler, and to perform audio functions.

### SUMMARY

The above and other needs are met by treat dispensing systems.

In one aspect, a treat dispensing system according to the disclosure includes a glove having a first electrical contact and a second electrical contact spaced from the first electrical contact, the first and second electrical contacts each mounted on the glove for being selectively placeable in contact with one another by deliberate manipulation of the glove by a user to place the first and second electrical contacts in contact with one another; and a first treat dispenser mounted on the glove.

The first treat dispenser includes a first treat storage compartment for storing first treats to be dispensed, a first computer controller in electronic communication with the first and second electrical contacts and selectively controllable to control operation of a first electric motor connected to the first computer controller and having a first rotatable output shaft, and a first auger extending between the first treat storage compartment and a first dispensing outlet, the first auger being connected to the first rotatable output shaft to rotate the first auger and to convey the first treats from the first treat storage compartment toward the first dispensing outlet in response to rotation of the first rotatable output shaft. When the user places the first and second electrical contacts on the glove in contact with one another the first computer controller provides power to the first electric motor to initiate a first rotation cycle and rotate the first output shaft and the first auger to dispense one of the first treats from the first dispensing outlet.

In another aspect, a treat dispensing system according to the disclosure includes a glove having a first electrical contact and a second electrical contact, the first and second electrical contacts each mounted on the glove for being selectively placeable in contact with one another by deliberate manipulation of the glove by a user to place the first and second electrical contacts in contact with one another; and a first treat dispenser mounted on the glove, the first treat dispenser including a first treat storage compartment for storing first treats to be dispensed, a first computer controller in electronic communication with the first and second electrical contacts and selectively controllable to control operation of a first treat conveyor operable to convey the first treats from the first treat storage compartment toward a first dispensing outlet. When the user places the first and second electrical contacts on the glove in contact with one another the first computer controller operates the first treat conveyor to dispense one of the first treats from the first dispensing outlet.

In a further aspect, a treat dispensing system according to the disclosure includes a first electrical contact and a second electrical contact selectively placeable in contact with one another by a user; a treat storage compartment for storing treats to be dispensed; an electric motor having a rotatable output shaft; and an auger extending between the treat storage compartment and a dispensing outlet, the auger being connected to the rotatable output shaft to rotate the auger and to convey the treats from the treat storage compartment toward the dispensing outlet in response to rotation of the rotatable output shaft. When the user places the first and second electrical contacts in contact with one another the electric motor initiates a rotation cycle and rotates the output shaft and the auger to selectively dispense the treats from the dispensing outlet one at a time.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 shows a treat dispensing system according to the disclosure and having a glove and a treat dispenser mounted on the glove being used by a dog handler to dispense a treat to a dog.

FIG. 2 shows additional treat dispensing structures in the form of a collar configured to dispense a treat.

FIGS. 3-6 show the glove and associated treat dispenser.

FIGS. 7-8 show the treat dispenser,

FIG. 9 shows a desired finger touching motion to activate dispensing of a treat from the treat dispenser mounted on the glove.

FIG. 10 shows a desired finger touching motion to activate dispensing of a treat from the treat dispenser mounted on the collar.

FIGS. 11-12 are perspective views of the collar.

FIGS. 13, 14A, 14B, and 14C show treat dispensing structures of the collar and their operation.

FIG. 15 depicts an audio function of the system.

### DETAILED DESCRIPTION

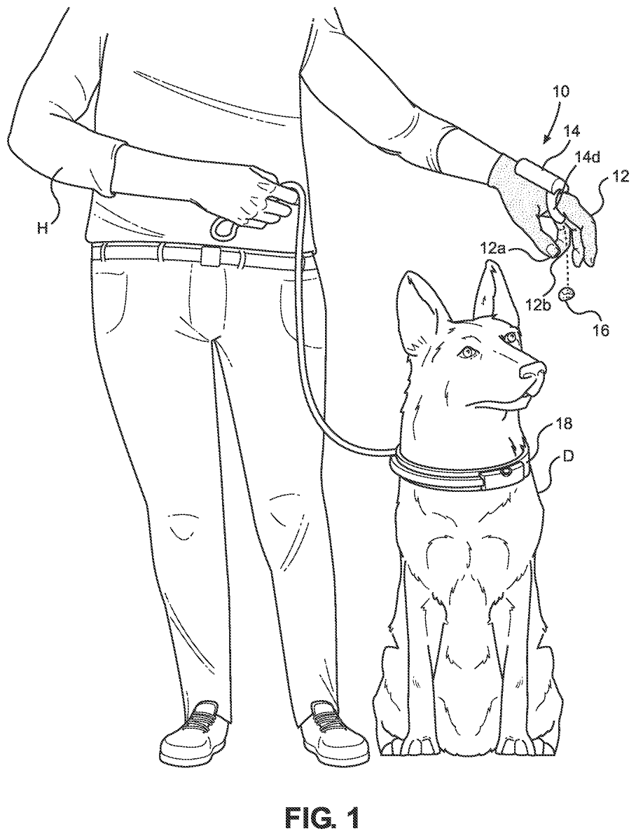

With initial reference to FIG. 1, there is shown a treat dispensing system 10 according to the disclosure having a glove 12 and a treat dispenser 14 integrated with the glove 12. The treat dispensing system 10 is configured to controllably and selectively dispense treats 16 to a dog D or other animal.

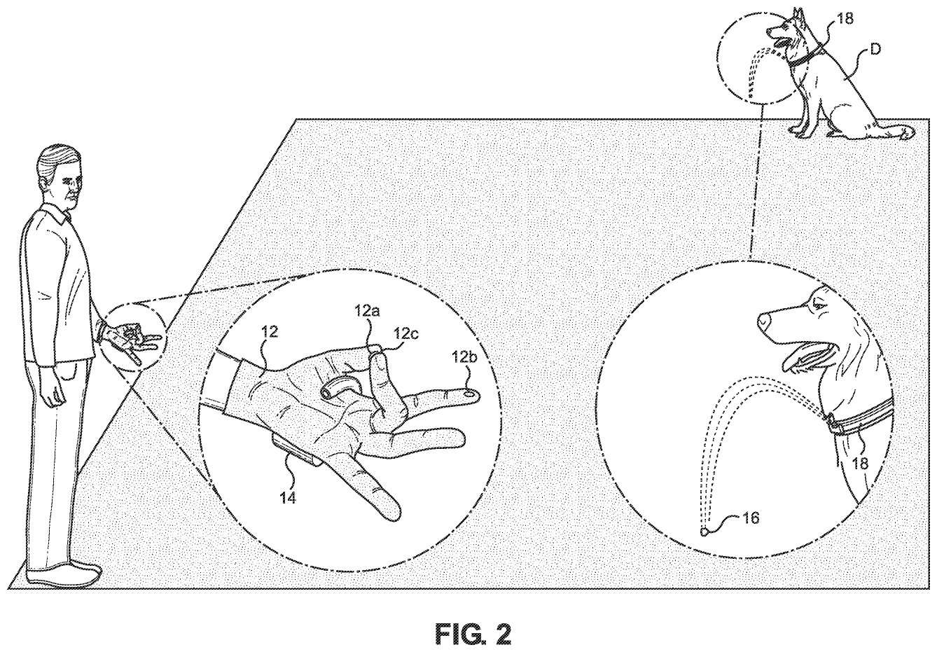

With additional reference to FIG. 2, the treat dispensing system 10 may also include a collar 18 worn by the dog D and configured to dispense the treats 16 and to perform audio functions as described more fully below.

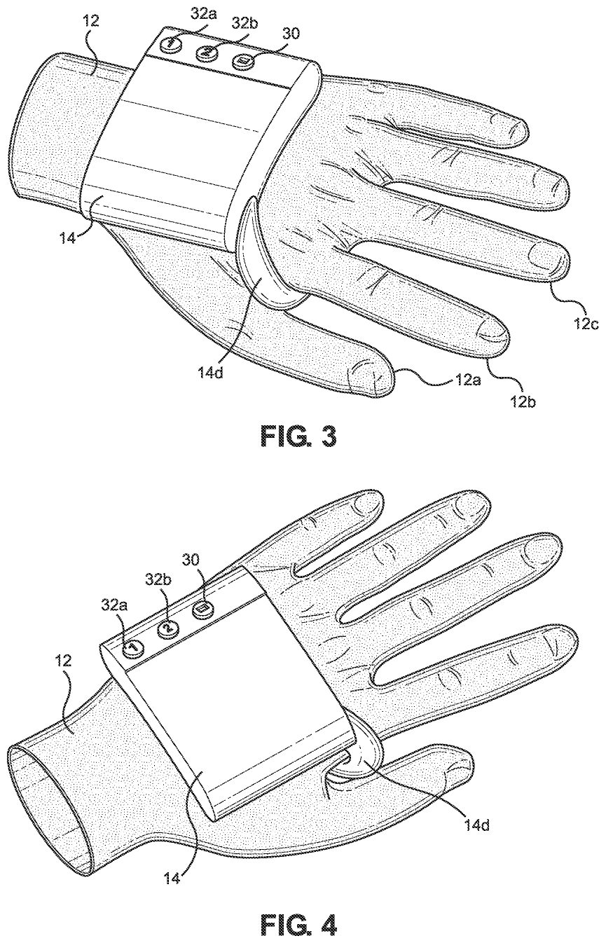

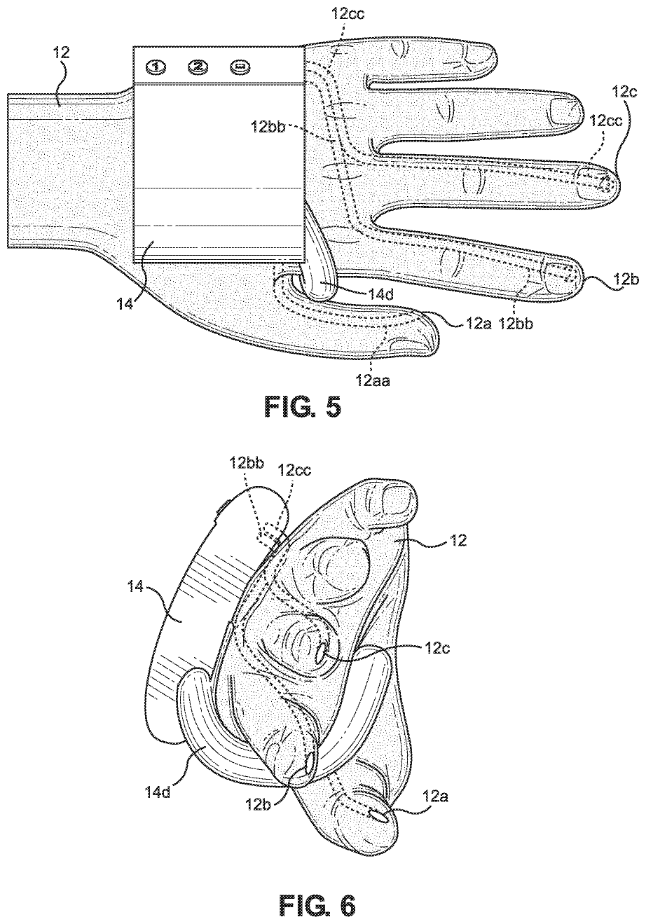

With reference to FIGS. 3-6, the glove 12 is generally configured as a conventional glove for fitting onto a hand, but preferably made with a fabric back and a polymer coated palm to be resistant to moisture such as saliva of the dog D when the glove 12 contacts the muzzle of the dog D when dispensing the treat 16 to the dog D. The glove 12 also serves to protect the hand of the trainer from the teeth of the dog and is desirably made of a fabric material that helps protect the hand of the training from the teeth of the dog taking the treat.

The glove 12 includes electrical contacts for electrically communicating with the treat dispenser 14 or the collar 18 to dispense the treats 16. For example, as shown the glove 12 includes electrical contacts 12a, 12b and 12c, located on a thumb, index finger, and middle finger, respectively of the glove 12. The contacts 12a and 12b are electrically communicative with the treat dispenser 14 via wires 12aa and 12bb. The contacts 12a and 12c are electrically communicative with the collar 18 via treat dispenser 14, via the wire 12aa and wire 12cc, as explained below.

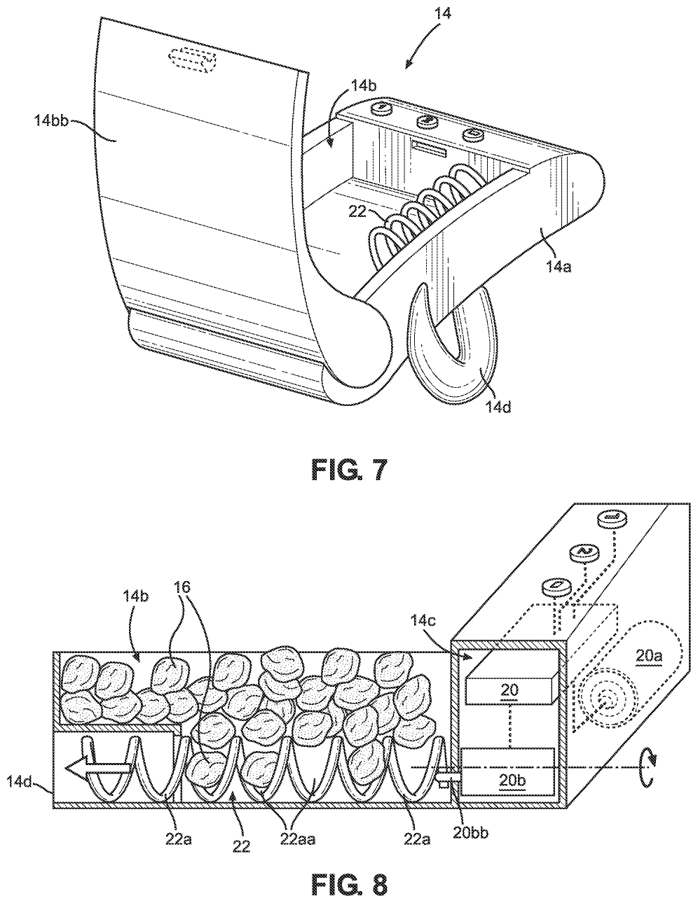

With additional reference to FIGS. 7 and 8, the treat dispenser 14 includes a housing 14a configured with a treat storage compartment 14b covered by a lid 14bb, an electronics compartment 14c, and a treat dispensing tube 14d.

As seen in FIG. 8, the treat dispensing tube 14d is a curved rigid tube formed of plastic configured as an output to dispense the treats 16 and positioned to deposit the dispensed treat 16 into the palm of the glove 12. If the handler wishes to not place the treat 16 in their palm, the handler can position their palm facing down and the treat 16 will drop down from the palm area of the hand, as shown in FIG. 1. The treats 16 may be a piece of dog food or kibble or other dog treat or the like food item suitable for use as a dog treat.

A computer controller in the form of an integrated circuit 20 is located in the electronics compartment 14c, along with a battery 20a and an electric motor 20b having a rotating output shaft 20bb. The circuit 20 and motor 20b are powered by the battery 20a. The wires 12aa, 12bb and 12cc of the contacts 12a, 12b, and 12c connect to the integrated circuit 20. A Bluetooth or other wireless connection and a related mobile application operated as by a personal computing device (phone, tablet, personal computer, or the like) is desirably utilized for programming and settings of the circuit 20 of the treat dispenser 14.

The treat dispenser 14 is preferably releasably attached to the glove 12 as by mating hook/loop material or the like to enable removal of the dispenser 14 from the glove 12 for washing of the glove 12 or the like. In this regard, the wires 12aa, 12bb and 12cc preferably connect to the electronics housing 14c via connectors that enable portions of the wires 12aa, 12bb, and 12cc to remain in the housing 14c and the portions of the wires 12aa, 12bb, and 12cc that are outside the housing 14c and connected to the glove 12 to be disconnected therefrom for removal of the dispenser 14 from the glove 12.

The shaft 20bb of the motor 20b is connected to a rotatable screw conveyor or auger 22 for configured to convey the treats 16 from the treat storage compartment 14b to the treat dispensing tube 14d to be dispensed. The opposite end of the auger 22 is free and the auger 22 rotates with the shaft 20bb. The auger 22 is made of a flexible material such as plastic that is generally rigid to hold its shape, but is flexible to flex for positioning between the compartment 14b and the tube 14d.

The auger 22 provides a helical conveyor having flights 22a. The auger 22 extends between the treat storage compartment 14b to just inside the dispensing tube 14d. The auger 22 has spaces 22aa between the flights 22a of the auger 22 which are slightly larger than the treat 16. The treats 16 are loaded into the auger 22 by gravity, such as when the handler lowers their hand to their side.

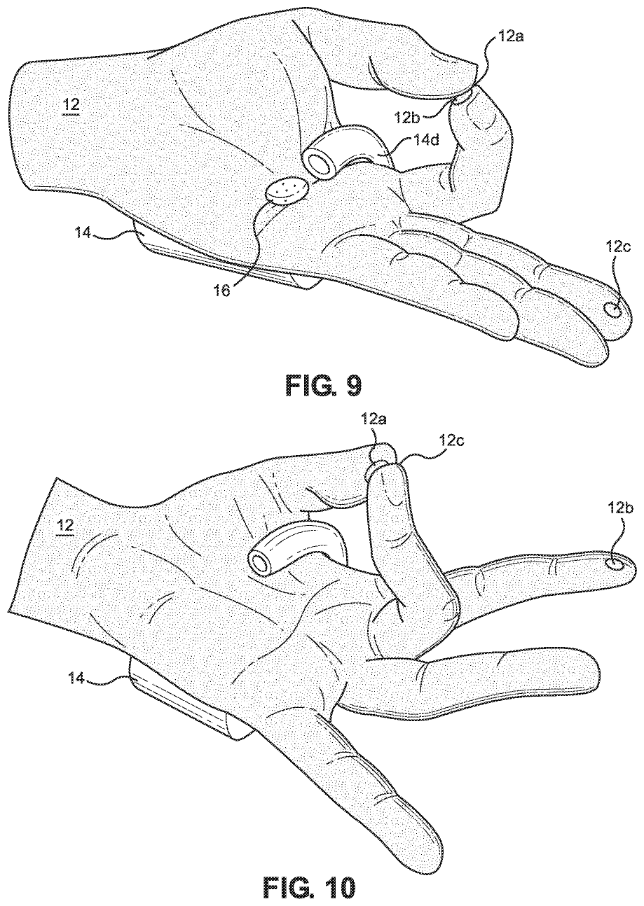

Activation of the motor 20b to rotate the auger 22 to convey the treats 16 is accomplished by the handler manipulating their thumb and index finger to touch the contacts 12a and 12b together as shown in FIGS. 1 and 9. This completes a circuit to power the motor 20b to index the motor 20b to rotate the auger 22 through one revolution. The handler will touch and release the contacts 12a and 12b to initiate a rotation cycle of the auger 22 sufficient to dispense one of the treats 16. If additional ones of the treats 16 are to be dispensed, the handler will initiate additional touches of the contacts 12a and 12b, with each contact generating operation of the dispenser 14 to dispense one of the treats 16.

An audible signal, such as a clicking sound, is also desirably emitted by the treat dispenser 14 when one of the treats 16 is dispensed from the tube 14d. The audible signal may be mechanical sound, such as the auger 22 striking the housing 14b when it rotates, or may be digital sound produced by the circuit 20 when the motor 20b is activated. This audible signal is desirable to facilitate training and has been observed to increase the speed at which the dog is rewarded following the marked behavior. This also enables the handler to more fluidly incorporate equipment, such as toys, into their training.

Returning to FIG. 2, and with additional reference to FIG. 10, the treat dispensing system 10 may also dispense the treats 16 via the collar 18 worn by the dog D. This is desirable when the dog D is located a distance from the handler. This is accomplished as by the handler touching their thumb and middle finger together to bring the contacts 12a and 12c of the glove 12 together to initiate a dispensing cycle to dispense one of the treats 16 from the collar 18.

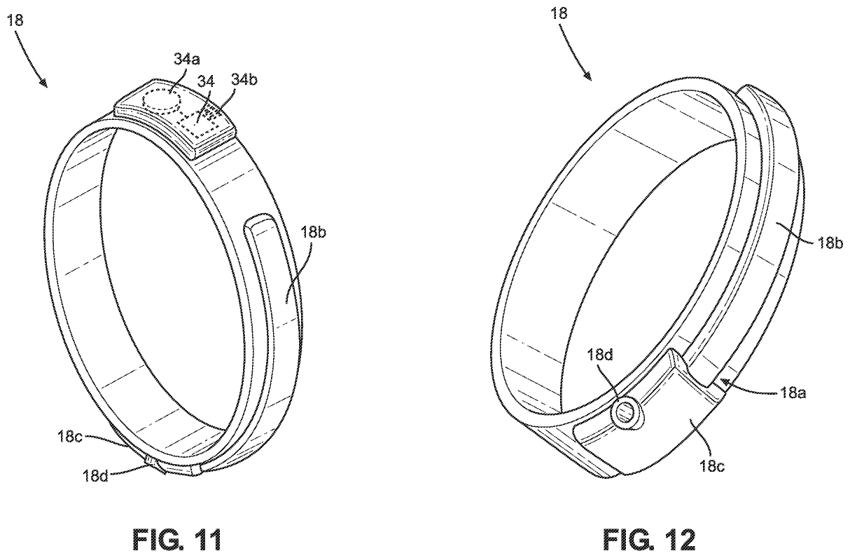

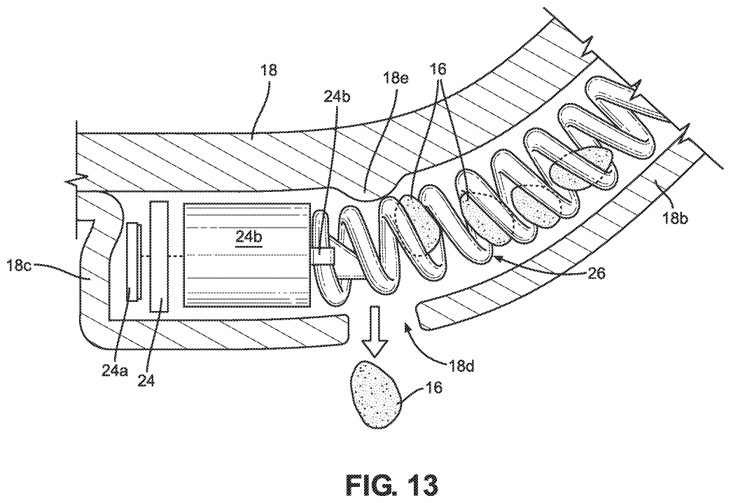

With reference to FIGS. 11, 12, and 13, the collar 18 includes a housing 18a having a treat storage compartment 18b, an electronics compartment 18c, and a treat dispensing port 18d. As shown in FIG. 13, an interior sidewall of the housing 18a opposite the treat dispensing port 18d includes a protrusion or bump 18e located just prior to and above the port 18d, and projecting inwardly towards the port 18d.

The collar 18 includes computer controller in the form of an integrated circuit 24 located in the electronics compartment 18c, along with a battery 24a and an electric collar motor 24b having a rotating output shaft 24bb. Treat dispensing from the collar 18 does not require Bluetooth or other interaction as the circuits 20 and 24 may be configured communicate directly.

The shaft 24bb is connected to a rotatable screw conveyor or auger 26 configured to convey the treats 16 from the treat storage compartment 18b to the treat dispensing port 18d to be dispensed. The auger 26 is similar in construction to the auger 22 and rotates with the shaft 24bb with the opposite end of the auger 26 not being fixed so auger 26 free to rotate. The auger 26 has flights 26a, with spaces 26aa between the flights 26a. The treats 16 are loaded into the auger 26 by gravity, as it is desirable to mount the collar 18 on the dog as shown, with the dispensing port 18d at the lowest point and the treat storage compartment 18b elevated above it.

A nose piece 28 having a sloped or beveled surface 28a is mounted on the end of the shaft 24bb and interacts with the treat 16 prior to its ejection. The nose piece 28 is mounted on the shaft 24bb interior of the auger 26 above the port 18d with the beveled surface 28a facing the advancing treats 16.

The bump 18e and the beveled surface 28a of the nose piece 28 cooperate with the auger 26 as the auger 26 rotates to stretch and tension the portion of the auger 26 holding the treat 16 located above the port 18d and to compress such treat 16. As the auger 26 continues to rotate, this portion of the auger 26 is released from the bump 18e such that the tension is released and the release of tension acts in the manner of a spring. This release of tension and the interaction of the beveled surface 28a with the treat 16 result in a forceful ejection of the treat 16 so that it is accelerated and shoots out of the port 18d such as depicted in FIG. 2.

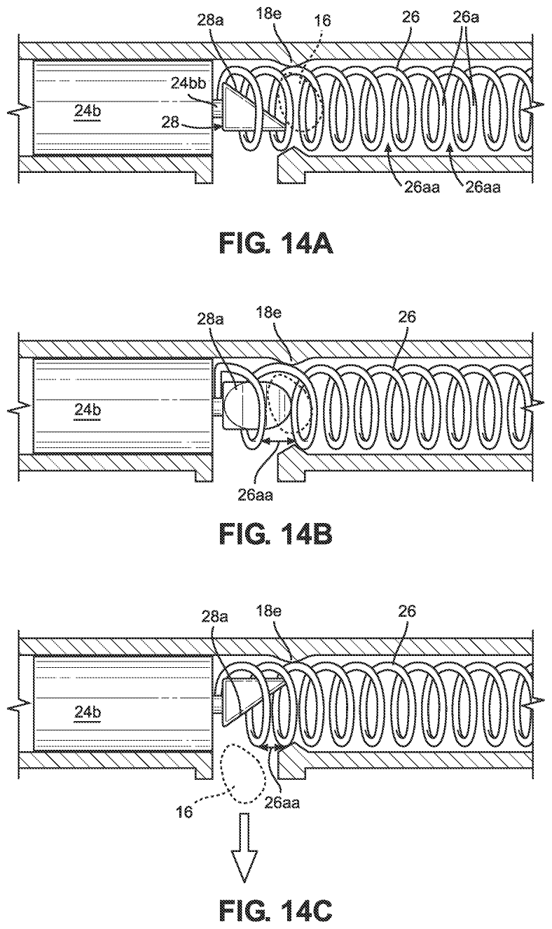

For example, with reference to FIGS. 14A, the auger 26 is shown in the relaxed state such as when the motor 24 is not operating or just after one of the treats 16 has been ejected and is ready to begin the next dispensing cycle. As will be noticed, the flight 26a proximate the bump 18e is in contact with the bump 18e and the treat 16 to be dispensed is in front of the beveled surface 28a, with the beveled surface 28a facing upward (180 degrees relative to the port 18d) blocking the treat 16 from falling through the port 18d.

Next, as shown in FIG. 14B as the motor 24 is activated to begin the dispensing cycle, which is one revolution of the shaft 20bb, the bump 18e impedes forward movement of the portion of the auger 26 proximate the bump 18e and stretches this portion of the auger 26. As depicted, the space 26aa of the flight 26a surrounding the nose piece 28 is stretched and is under tension. As part of this, the treat 16 is compressed between the beveled surface 28a and the sidewall of the housing as the shaft 24bb rotates and the beveled surface 28a is rotated to be 90 degrees relative to the port 18d.

In the final stage of the dispensing cycle as shown in FIG. 14C, the motor 24 continues to rotate the shaft 24bb to rotate the beveled surface 28a to face the port 18d. Simultaneous with this, the portion of the auger 26 proximate the bump 18e is released from the bump 18e and the tension of this portion of the auger 26 is released and the flight 26a surrounding the nose piece 28 quickly snaps back to its untensioned state (with the space 26aa shown returning to the same size as the other spaces 26aa of the auger). As a result, the release of tension forcefully ejects the treat 16 and the beveled surface 28 directs the treat 16 out the port 18d as shown. This release of tension from the auger 26 also provides a corresponding sound that serves as a cue to signal to the dog D that the treat 16 is being dispensed.

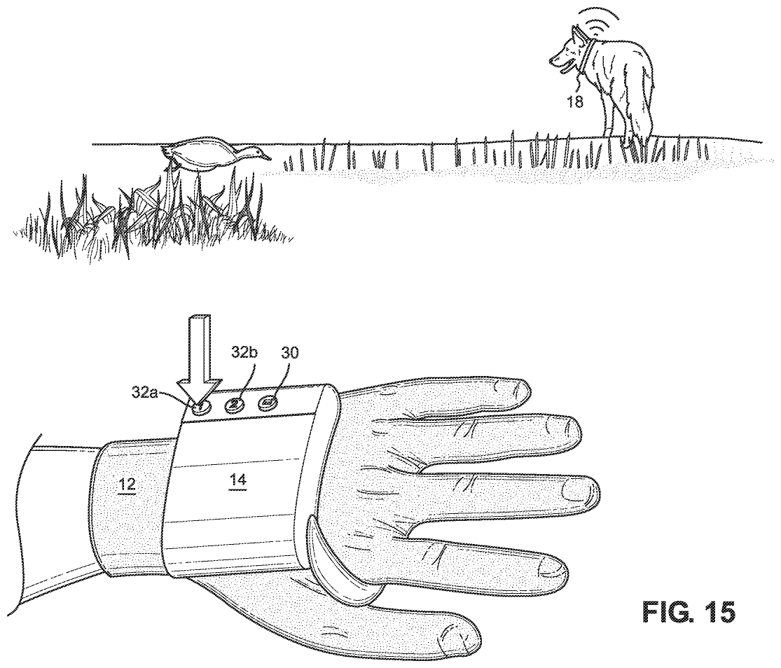

Returning now to FIGS. 4 and 11, and with reference to FIG. 15, another feature of the system 10 is the provision of audio functions to provide audible commands to the dog D. For example, as shown, the treat dispenser 14 includes a record button 30 and playback buttons 32a and 32b, which cooperate with the collar 18.

In this regard, the collar 18 includes a computer controller in the form of a microprocessor or integrated circuit 34 located in a housing 36. The circuit 34 is connected to an internal speaker 34a and a battery 34b. The record button 30 is used to record audio, such as voice commands, to the circuit 34 of the collar 18 via a cooperating mobile app on a personal computing device as explained more fully below. The playback buttons 32a and 32b are used to activate the circuit 34 to play the selected audio via the speaker 34a of the collar 18.

A Bluetooth or other wireless connection and a related mobile application operated as by a personal computing device 40 (phone, tablet, personal computer, or the like) are desirably utilized for connection between the circuit 20 of the treat dispenser 14 and the circuit 34 of the collar 18, and programming of the circuits 20 and 34 for recording of audio such as the voice commands.

In one configuration, all verbal commands are recorded into the software application associated with the personal computing device 40. The handler may then pair the treat dispenser 14 and the collar 18. In one configuration, the buttons 32a/32b on the transmits signals to the personal computing device 40 which, in turn, transmits the recorded message to the circuit 34 of the collar. This method also validates outputs from the glove.

For example, with connection between circuit 20, the circuit 34, and the mobile app of the personal computing device 40, the record button 30 is pressed once and the handler will speak into a microphone of the computing device 40 to record a first voice command onto memory of the circuit 34. The record button 30 may be pressed twice in quick succession to record a second voice command. The voice commands may then be played to the dog D via the collar 18, with the collar able to be relatively remote but still within signal distance from the treat dispenser 14.

For example, to play the first voice command via the speaker 34a, the handler may press the playback button 32a and the microprocessor 34 will play the first voice command via the speaker 34a. Likewise, the handler may press the playback button 32b to have the second voice command played. This is especially useful for distance commands, for example with hunting dogs where the handler may command the dog to move in a specific direction to find the game. Commands recorded by the handler, in their own voice, are preferred over other sounds, and are believed to increase effectiveness of training, and decrease training time and improving accuracy.

In another configuration, playback signals from the circuit 20 communicate with the circuit 34 directly via a wireless connection. The circuits 20 and 34 may be directly connected for recording the commands via a wired connection which can be removed once recording is accomplished. It will be appreciated that the connection between the circuits 20 and 34 and storage of recorded audio and the triggering of the playback of the recorded audio from the speaker 34a in the collar 18 may be accomplished in various manners.

Examples of voice commands for hunting dogs are as follows. The voice command “Here” is used to have the dog return to the handler. For example, the dog is 100 yards away from the handler and the “Here” voice command is played via the collar 18 to signal the dog to return to the handler. The voice command “Hunt.” The dog is 100 yards out, the dog is unable to pick up the scent of the game so the handler commands via the collar that the dog turn right, which is the direction of the prey and finally pick up the scent. Dogs can have issues if the wind is blowing in various directions. The voice command “down” or “wait.” The dog is far from handler and handler recognizes that the dog may be approaching a dangerous situation or pausing for a next command.

Accordingly, the disclosure advantageously provides a treat dispensing system that enables a handler to quickly and easily dispense a treat. The treat dispensing system is also advantageously configured to enable a treat to be dispensed even if the dog is remote from the handler, and to perform audio functions.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A treat dispensing system, comprising:
a glove having a first electrical contact and a second electrical contact spaced from the first electrical contact, the first and second electrical contacts each mounted on the glove for being selectively placeable in contact with one another by deliberate manipulation of the glove by a user to place the first and second electrical contacts in contact with one another; and
a first treat dispenser mounted on the glove, the first treat dispenser including a first treat storage compartment for storing first treats to be dispensed, a first computer controller in electronic communication with the first and second electrical contacts and selectively controllable to control operation of a first electric motor connected to the first computer controller and having a first rotatable output shaft, and a first auger extending between the first treat storage compartment and a first dispensing outlet, the first auger being connected to the first rotatable output shaft to rotate the first auger and to convey the first treats from the first treat storage compartment toward the first dispensing outlet in response to rotation of the first rotatable output shaft;
wherein when the user places the first and second electrical contacts on the glove in contact with one another the first computer controller provides power to the first electric motor to initiate a first rotation cycle and rotate the first output shaft and the first auger to dispense one of the first treats from the first dispensing outlet.

2. The treat dispensing system of claim 1, wherein the first electrical contact is on a thumb of the glove and the second electrical contact is on a finger of the glove.

3. The treat dispensing system of claim 1, wherein the first dispensing outlet is configured to have an output end located adjacent a palm portion of the glove.

4. The treat dispensing system of claim 1, wherein the first treat dispenser generates an audible sound during the first rotation cycle.

5. The treat dispensing system of claim 1, further comprising a third electrical contact mounted on the glove in electrical communication with the first computer controller and spaced apart from the first and second electrical contacts and located for being selectively placeable in contact with the first electrical contact by deliberate manipulation of the glove by the user; and a treat dispensing collar positionable on a dog, the treat dispensing collar including a collar and a second treat dispenser mounted on the collar, the second treat dispenser including a second treat storage compartment for storing second treats to be dispensed, a second computer controller in electronic communication with the first computer controller and selectively controllable to control operation of a second electric motor connected to the second computer controller and having a second rotatable output shaft, and a second auger extending between the second treat storage compartment and a second dispensing outlet located on the collar, the second auger being connected to the second rotatable output shaft to rotate the second auger and to convey the second treats from the second treat storage compartment to the second dispensing outlet in response to rotation of the second rotatable output shaft;
wherein when the user places the first and third electrical contacts on the glove in contact with one another the first computer controller communicates with the second computer controller to provide power to the second electric motor to initiate a second rotation cycle and rotate the second output shaft and the second auger to dispense one of the second treats from the second dispensing outlet.

6. The treat dispensing system of claim 6, wherein the second computer controller is operable to play audio through a speaker operatively associated with the second computer controller.

7. A treat dispensing system, comprising:
a glove having a first electrical contact and a second electrical contact, the first and second electrical contacts each mounted on the glove for being selectively placeable in contact with one another by deliberate manipulation of the glove by a user to place the first and second electrical contacts in contact with one another; and
a first treat dispenser mounted on the glove, the first treat dispenser including a first treat storage compartment for storing first treats to be dispensed, a first computer controller in electronic communication with the first and second electrical contacts and selectively controllable to control operation of a first treat conveyor operable to convey the first treats from the first treat storage compartment toward a first dispensing outlet;
wherein when the user places the first and second electrical contacts on the glove in contact with one another the first computer controller operates the first treat conveyor to dispense one of the first treats from the first dispensing outlet.

8. The treat dispensing system of claim 7, wherein the first electrical contact is on a thumb of the glove and the second electrical contact is on a finger of the glove.

9. The treat dispensing system of claim 7, wherein the first dispensing outlet is configured to have an output end located adjacent a palm portion of the glove.

10. The treat dispensing system of claim 7, wherein the first treat dispenser generates an audible sound during dispensing of the first treat.

11. The treat dispensing system of claim 7, further comprising a third electrical contact on the glove in electrical communication with the first computer controller; and a treat dispensing collar positionable on a dog, the treat dispensing collar including a collar and a second treat dispenser mounted on the collar, the second treat dispenser including a second treat storage compartment for storing second treats to be dispensed, a second computer controller in electronic communication with the first computer controller and selectively controllable to control operation of a second treat conveyor operable to convey the second treats from the second treat storage compartment toward a second dispensing outlet
wherein when the user places the first and third electrical contacts on the glove in contact with one another the first computer controller communicates with the second computer controller to operate the second treat conveyor to dispense one of the second treats from the second dispensing outlet.

12. The treat dispensing system of claim 11, wherein the second computer controller is operable to play audio through a speaker operatively associated with the second computer controller.

13. A treat dispenser, comprising:
a first electrical contact and a second electrical contact selectively placeable in contact with one another by a user;
a treat storage compartment for storing treats to be dispensed;
an electric motor having a rotatable output shaft; and
an auger extending between the treat storage compartment and a dispensing outlet, the auger being connected to the rotatable output shaft to rotate the auger and to convey the treats from the treat storage compartment toward the dispensing outlet in response to rotation of the rotatable output shaft;
wherein when the user places the first and second electrical contacts in contact with one another the electric motor initiates a rotation cycle and rotates the output shaft and the auger to selectively dispense the treats from the dispensing outlet one at a time.

14. The treat dispenser of claim 13, wherein the first electrical contact and the second electrical contact are located on a glove and the treat storage compartment is mounted on the glove.

15. The treat dispenser of claim 13, wherein the auger is located in a housing having an interior sidewall opposite the dispensing outlet and a protrusion is located on the interior sidewall just prior to and above the dispensing outlet, and projecting inwardly towards the dispensing outlet, and wherein the protrusion contacts a portion of the auger as the auger rotates to stretch and tension the portion of the auger located above the port, and as the auger continues to rotate, this portion of the auger is released from the bump projection such that the tension in the portion of the auger is released and the release of tension acts in the manner of a spring and the dispensing of the treat is a forceful ejection of the treat out of the dispensing outlet.

16. The treat dispenser of claim 15, further comprising a nose piece having a sloped surface mounted on the end of the rotating output shaft and shaft, wherein the sloped surface is configured to interact with the treat as it is dispensed to direct it toward the dispensing outlet.
